(19) United States
(12) Patent Application Publication
(10) Pub. No.: US 2010/0268467 A1
(43) Pub. Date: Oct. 21, 2010

(54) Lightning detection

(75) Inventors: Jakke S. Makela, Turku (FI); Niko S. Porjo, Piikkio (FI)

Correspondence Address: HARRINGTON & SMITH, 4 RESEARCH DRIVE, Suite 202, SHELTON, CT, 06484-6212, US

(73) Assignee: Nokia Corporation

(21) Appl. No.: 12/386,378

(22) Filed: Apr. 17, 2009

(51) Int. Cl. G01W 1/00; G06F 19/00

(52) U.S. Cl. 702/4

(57) ABSTRACT

A method, an apparatus, and a computer program is provided. The method includes: quantizing a received time-varying radio frequency signal to produce a series of digital values; maintaining a plurality of data groups, each data group including a cumulative parameter and each data group being defined by a digital value range, wherein maintaining the plurality of data groups includes updating a cumulative parameter for a data group, from the plurality of data groups, when a digital value, from the series of digital values, is within the digital value range for that data group; and processing at least some of the cumulative parameters of the data groups to determine whether the received time-varying radio frequency signal originated from lightning.

### FIELD OF THE INVENTION

Embodiments of the present invention relate to lightning detection. In particular, they relate to detecting lightning by processing a received time-varying radio frequency signal.

### BACKGROUND TO THE INVENTION

Lightning is an atmospheric discharge of electricity, which results in electromagnetic signals being produced in the radio frequency range. A lightning detector may detect lightning by determining whether a received radio signal has properties that are characteristic of radio signals produced by lightning.

### BRIEF DESCRIPTION OF VARIOUS EMBODIMENTS OF THE INVENTION

According to various, but not necessarily all, embodiments of the invention there is provided a method, comprising: quantizing a received time-varying radio frequency signal to produce a series of digital values; maintaining a plurality of data groups, each data group comprising a cumulative parameter and each data group being defined by a digital value range, wherein maintaining the plurality of data groups comprises updating a cumulative parameter of a data group, from the plurality of data groups, when a digital value, from the series of digital values, is within the digital value range for that data group; and processing at least some of the cumulative parameters of the data groups to determine whether the received time-varying radio frequency signal originated from lightning.

Processing at least some of the cumulative parameters may comprise determining whether a distribution, formed using at least some of the cumulative parameters, follows a trend.

The number of digital values produced from quantizing the received time-varying radio frequency signal may be greater than the number of maintained data groups.

The method may further comprise storing, after updating cumulative parameters of the plurality of data groups, at least some of the updated cumulative parameters prior to processing, but not storing the produced digital values.

Maintaining the plurality of data groups may comprise allocating a digital value, from the series of digital values, to a data group, from the plurality of data groups, prior to updating the cumulative parameter of that data group.

The method may further comprise down-converting the time-varying radio frequency signal from a first frequency to a second, lower, frequency prior to quantizing the time-varying radio frequency signal. The second frequency may be equivalent to an audio frequency and the time-varying radio frequency signal may be quantized using audio processing circuitry.

According to various, but not necessarily all, embodiments of the invention there is provided an apparatus, comprising: quantization circuitry configured to quantize a received time-varying radio frequency signal to produce a series of digital values; maintenance circuitry configured to maintain a plurality of data groups, each data group comprising a cumulative parameter and each data group being defined by a digital value range, wherein maintaining the plurality of data groups comprises updating a cumulative parameter of a data group, from the plurality of data groups, when a digital value, from the series of digital values, is within the digital value range for that data group; and processing circuitry configured to process at least some of the cumulative parameters of the data groups to determine whether the received time-varying radio frequency signal originated from lightning.

The apparatus may be for detection of lightning.

The processing circuitry may be configured to process at least some of the cumulative parameters by determining whether a distribution, formed using at least some of cumulative parameters, follows a trend.

The number of digital values produced from quantizing the received time-varying radio frequency signal may be greater than the number of maintained data groups.

The maintenance circuitry may be configured to store, after updating cumulative parameters of the plurality of data groups, at least some of the updated cumulative parameters prior to processing, but not to store the produced series of digital values.

The maintenance circuitry may be configured to allocate a produced digital value to a data group, from the plurality of data groups, prior to updating the cumulative parameter of that data group.

The apparatus may further comprise a down-converter configured to down-convert the time-varying radio frequency signal from a first frequency to a second, lower, frequency prior to quantizing the time-varying radio frequency signal.

The second frequency may be equivalent to an audio frequency and the quantization circuitry may be further configured to quantize received audio signals.

According to various, but not necessarily all, embodiments of the invention there is provided a tangible computer-readable storage medium storing a computer program comprising instructions which, when executed by a processor, enable: maintaining a plurality of data groups, each data group comprising a cumulative parameter and each data group being defined by a digital value range, wherein maintaining the plurality of data groups comprises updating a cumulative parameter of a data group, from the plurality of data groups, when a digital value, produced from quantization of a received time-varying radio frequency signal, is within the digital value range for that data group; and processing at least some of the cumulative parameters of the data groups to determine whether the received time-varying radio frequency signal originated from lightning.

According to various, but not necessarily all, embodiments of the invention there is provided an apparatus, comprising: means for quantizing a received time-varying radio frequency signal to produce a series of digital values; means for maintaining a plurality of data groups, each data group comprising a cumulative parameter and each data group being defined by a digital value range, wherein maintaining the plurality of data groups comprises updating a cumulative parameter of a data group, from the plurality of data groups, when a digital value, from the series of digital values, is within the digital value range for that data group; and means for processing at least some of the cumulative parameters of the data groups to determine whether the received time-varying radio frequency signal originated from lightning.

The means for processing may determine whether a distribution, formed from at least some of cumulative parameters, follows a trend.

According to various, but not necessarily all, embodiments of the invention there is provided an electronic device, comprising: processing circuitry configured to detect a series of radio frequency pulses, the radio frequency pulses being generated from sequential switching of a mains electricity supply of a building by a user, and the processing circuitry being configured, in response to detection of the series of radio frequency pulses, to change a state of the electronic device.

The processing circuitry may be configured to determine at least one characteristic of the series of radio frequency pulses, and to compare the determined at least one characteristic with at least one parameter stored in a memory. The processing circuitry may be configured, when the determined at least one characteristic corresponds with the stored parameter, to change a state of the electronic device.

The at least one characteristic may relate to the duration of each of the detected radio frequency pulses, the time spacing between sequentially detected radio frequency pulses and/or the intensity of the detected radio frequency pulses.

The processing circuitry may be configured, in response to detection of the series of radio frequency pulses, to change the electronic device from being in a first state to being in a second state.

The electronic device may be a mobile radio telephone. When the mobile radio telephone is in the first state, it may be configured not to produce an audible alert in response to an incoming telephone call and/or an incoming text message. The first state may, for example, be a silent mode of the mobile radio telephone.

When the mobile radio telephone is in the second state, it may be configured to produce an audible alert. The mobile radio telephone may be configured to produce the audible alert in response to entering the second state. Alternatively or additionally, the mobile radio telephone may be configured to produce an audible alert, when in the second state, in response to an incoming telephone call and/or an incoming text message.

According to various, but not necessarily all, embodiments of the invention there is provided a method, comprising: detecting a series of radio frequency pulses, the radio frequency pulses being generated from sequential switching of a mains electricity supply of a building by a user; and changing, in response to detection of the series of radio frequency pulses, a state of an electronic device.

According to various, but not necessarily all, embodiments of the invention there is provided a computer program comprising instructions which, when executed by a processor, enable: detecting a series of radio frequency pulses, the radio frequency pulses being generated from sequential switching of a mains electricity supply of a building by a user; and changing, in response to detection of the series of radio frequency pulses, a state of an electronic device.

According to various, but not necessarily all, embodiments of the invention there is provided an electronic device, comprising: means for detecting a series of radio frequency pulses, the radio frequency pulses being generated from sequential switching of a mains electricity supply of a building by a user; and means for changing, in response to detection of the series of radio frequency pulses, a state of the electronic device.

### BRIEF DESCRIPTION OF THE DRAWINGS

For a better understanding of various examples of embodiments of the present invention reference will now be made by way of example only to the accompanying drawings in which:

FIG. 1 illustrates an apparatus;

FIG. 2 illustrates a digital processing part;

FIG. 3A illustrates a radio signal produced by lightning;

FIG. 3B illustrates a radio signal produced by a man-made source;

FIG. 4 illustrates a method;

FIG. 5 illustrates an inverse cumulative distribution function for a radio signal produced by lightning;

FIG. 6 illustrates an inverse cumulative distribution function for a radio signal produced by a man-made source; and

FIG. 7 illustrates a semi-log graph of an inverse cumulative distribution function for a radio signal produced from lightning.

### DETAILED DESCRIPTION OF VARIOUS EMBODIMENTS OF THE INVENTION

The Figures illustrate an apparatus 100, comprising: quantization circuitry 42 configured to quantize a received time-varying radio frequency signal 15 to produce a series of digital values; maintenance circuitry 44 configured to maintain a plurality of data groups, each data group comprising a cumulative parameter and each data group being defined by a digital value range, wherein maintaining the plurality of data groups comprises updating a cumulative parameter of a data group, from the plurality of data groups, when a digital value, from the series of digital values, is within the digital value range for that data group; and processing circuitry 46 configured to process at least some of the cumulative parameters of the data groups to determine whether the received time-varying radio frequency signal 15 originated from lightning.

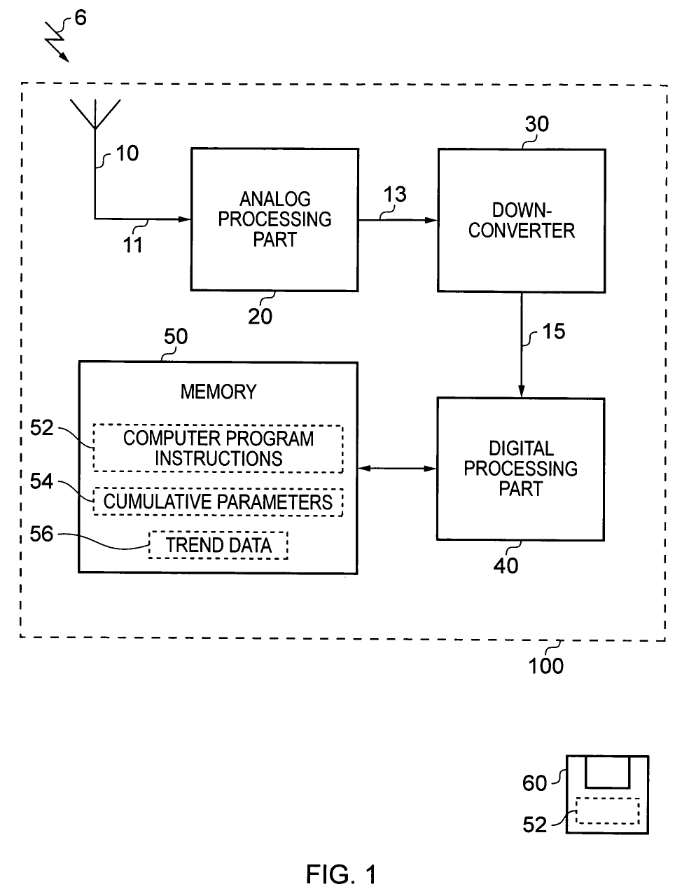

FIG. 1 illustrates an apparatus 100. The apparatus 100 may, for example, be an electronic device, a part of an electronic device or a module for an electronic device. The electronic device may be a hand-portable device, such as a mobile telephone, a personal music player or a personal digital assistant. In the embodiments of the invention where the apparatus 100 is a module for an electronic device, the module may or may not be user-attachable to the electronic device and/or user-detachable from the electronic device.

The apparatus 100 comprises an antenna 10, an analog processing part 20, a down-converter 30, a digital processing part 40 and a memory 50. The analog processing part 20, the down-converter 30, the digital processing part 40 and the memory 50 are electronic circuitry.

The antenna 10 is configured to receive time-varying radio frequency signals 6. The time-varying radio frequency signals 6 may originate from lightning or a man-made source. The antenna 10 may, for example, be configured to receive time-varying radio frequency signals in the megahertz (MHz) or gigahertz (MHz) range.

In some embodiments of the invention, the antenna 10 may be dedicated to receiving radio signals that are subsequently analyzed to determine whether they originated from lightning. In other embodiments of the invention, the antenna 10 may also receive radio signals for other purposes. For example, if the apparatus 100 forms part of a mobile radio telephone, the antenna 10 may be configured to receive radio signals relating to telephony.

The analog processing part 20 is configured to receive time-varying analog radio frequency signals 11 as an input from the antenna 10. The analog processing part 20 is further configured to process received time-varying analog radio frequency signals 11 and to provide time-varying analog radio frequency signals 13 as an output to the down-converter 30. The time-varying radio frequency analog signal 13 that is output to the down-converter 30 may or may not be the same as the time-varying analog radio frequency signal 11 that is received as an input from the antenna 10.

The down-converter 30 is configured to receive time-varying analog radio frequency signals 13 from the analog processing part 20 and to down-convert them from a first frequency to a second, lower, frequency. The down-converter is further configured to provide down-converted time-varying analog radio frequency signals 15 to the digital processing part 40.

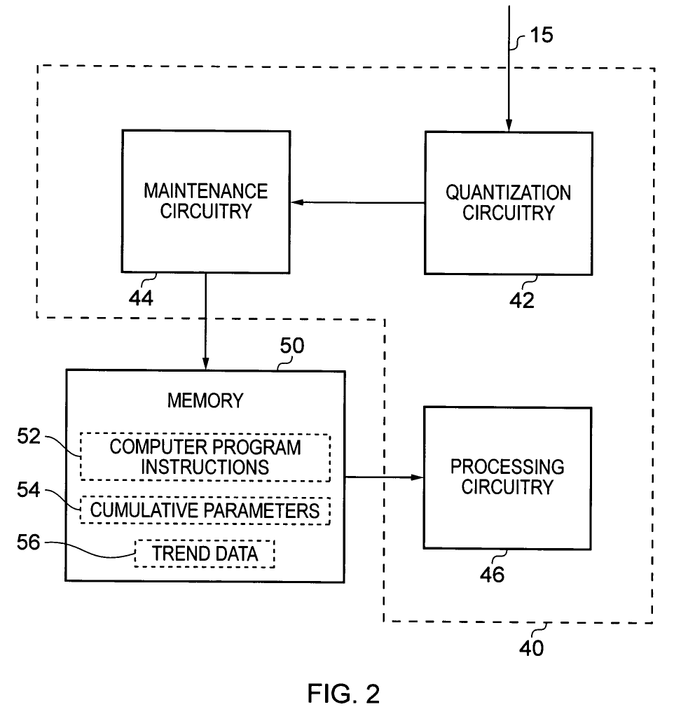

FIG. 2 illustrates the digital processing part 40 in more detail. The digital processing part 40 comprises quantization circuitry 42, maintenance circuitry 44 and processing circuitry 46.

The quantization circuitry 42 is configured to receive down-converted time-varying analog radio frequency signals 15 from the down-converter 30. The quantization circuitry 42 is further configured to quantize down-converted time-varying analog radio frequency signals 15 to produce a series of digital values and to provide the digital values to the maintenance circuitry 44 as an output.

The maintenance circuitry 44 is configured to receive digital values from the quantization circuitry 42 as an input. The maintenance circuitry 44 is further configured to maintain a plurality of data groups. Each data group comprises a cumulative parameter and each data group is defined by a digital value range. Maintaining the plurality of data groups comprises updating the cumulative parameter for a data group when a digital value, received from the quantization circuitry 42, is within the digital value range for that data group.

The maintenance circuitry 44 is further configured to write data, such as updated cumulative parameters 54, to the memory 50.

The processing circuitry 46 is configured to read data from the memory 50. For example, the processing circuitry 46 may read computer program instructions 52, cumulative parameters 54 and/or trend data 56 from the memory 50. The processing circuitry 46 is further configured to process at least some of the cumulative parameters 54 of the data groups to determine whether the received time-varying radio frequency signal 6, 11, 13, 15 originated from lightning.

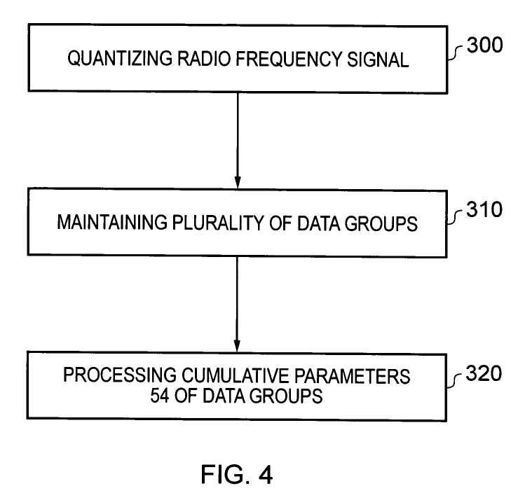

The memory 50 stores a computer program comprising computer program instructions 52 that control the operation of the apparatus 100 when loaded into the processing circuitry 46. The computer program instructions 52 provide the logic and routines that enables the apparatus 100 to perform the methods illustrated in FIG. 4. The processing circuitry 46, by reading the memory 50, is able to load and execute the computer program.

The computer program instructions 52 may arrive at the apparatus 100 via any suitable delivery mechanism 60. The delivery mechanism 60 may be, for example, a computer-readable storage medium, a computer program product, a memory device, a record medium such as a CD-ROM or DVD, an article of manufacture that tangibly embodies the computer program instructions 52. The delivery mechanism 60 may be a signal configured to reliably transfer the computer program instructions 52.

The apparatus 100 may propagate or transmit the computer program instructions 52 as a computer data signal.

Although the memory 50 is illustrated as a single component it may be implemented as one or more separate components some or all of which may be integrated/removable and/or may provide permanent/semi-permanent/dynamic/cached storage.

References to “tangible computer-readable storage medium”, “analog processing part”, down-converter”, “digital processing part”, “quantization circuitry”, “maintenance circuitry” and “processing circuitry” etc. should be understood to encompass not only computers having different architectures such as single/multi- processor architectures and sequential (Von Neumann)/parallel architectures but also specialized circuits such as field-programmable gate arrays (FPGA), application specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

An example of a method according to embodiments of the invention will now be described in detail. A time-varying analog radio frequency signal 6 is received by the antenna 10. In this particular example, the received time-varying analog radio frequency signal 6 has a frequency of 1 MHz. However, it will be apparent to those skilled in the art that radio signals of other frequencies may be received by the antenna 10.

The antenna 10 provides the time-varying radio frequency signal 11 (in electrical form) to the analog processing part 20. The analog processing part 20 performs analog processing on the time-varying radio frequency signal 11 to determine whether the time-varying radio frequency signal 11 has characteristics that indicate that it may have originated from lightning.

If the analog processing part 20 determines that the time-varying radio frequency signal 11 has characteristics that indicate that it may have originated from lightning, the radio signal 11 is provided to the down-converter 30. Otherwise, the radio signal 11 is not provided to the down-converter 30.

Time varying radio frequency signals that originate from lightning typically include one or more pronounced peaks. The analog processing circuitry 20 may, for example, analyze the received time-varying radio frequency signal to determine whether it includes such peaks. If so, the radio signal 11 is provided to the down-converter 30. Otherwise, the radio signal is not provided to the down-converter 30.

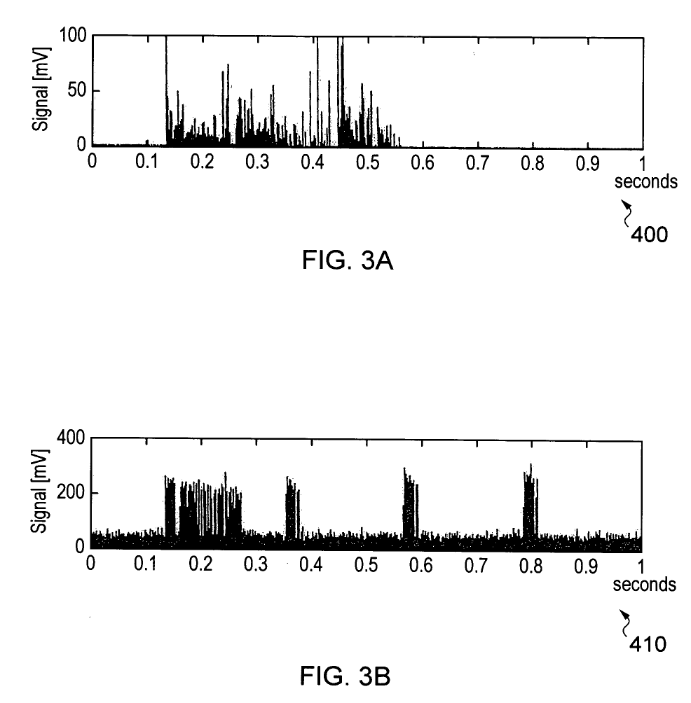

FIG. 3A illustrates a graph 400. The graph 400 illustrates an example of a time-varying radio frequency signal produced by lightning. The y-axis indicates the intensity of the signal and the x-axis indicates time. It can be seen from the figure that there is a large amount of fluctuation in the intensity of the signal. The signal has a small number of very high peaks and a larger amount of smaller “local” peaks.

FIG. 3B illustrates a graph 410. The graph 410 illustrates an example of a time-varying radio frequency signal produced by a man-made source. The y-axis indicates the intensity of the signal and the x-axis indicates time. The man-made signal has a number of high peaks and a large amount of “baseline” noise. There are not, however, many values intermediate the baseline noise and the high peaks.

If the analog processing part 20 is configured to analyze a received time-varying radio frequency signal 11 to determine whether the radio signal 11 includes relatively high peaks, it will pass the radio signal illustrated in FIG. 3A to the down-converter 30. However, depending upon the configuration of the analog processing part 20, it may also pass radio signals from man-made sources, such as that illustrated in FIG. 3B, to the down-converter 30. It may therefore be desirable to perform further processing on a received radio signal in order to determine whether it originates from lightning or a man-made source.

The down-converter 30 reduces the frequency of the time-varying radio frequency signal 13 that it receives from the analog processing part 20 from 1 MHz to a lower frequency. In this example, the frequency of the radio signal 13 is reduced from 1 MHz to 20 Hz. It will, however, be appreciated by those skilled in the art that the radio signal 13 could be converted to a different frequency.

Down-conversion of the time-varying radio frequency signal 13 results in the radio signal 13 being “smoothed”, because an envelope of the radio signal 13 is taken. The down-converted radio signal 15 is then provided to the quantization circuitry 42 of the digital processing part 40.

Audio signals also have frequencies of the order of 20 Hz. Selection of a down-conversion frequency of 20 Hz advantageously enables embodiments of the invention to re-use audio processing circuitry to process down-converted radio signals. For example, the quantization circuitry 42 may also be used to quantize audio signals.

In block 300 of FIG. 4, the down-converted time-varying radio frequency signal 15 is quantized by the quantization circuitry 42 to produce a series of digital values.

The quantization circuitry 42 is configured to sample a received down-converted radio signal 15 at an appropriate rate, depending upon the frequency of the down-converted radio signal 15. If the frequency of the down-converted radio signal 15 is 20 Hz, the sampling rate may, for example, be 44.1 kHz.

The quantization circuitry 42 outputs a series of digital values to the maintenance circuitry 44. In this particular example, the digital values that are output to the maintenance circuitry 44 are voltages. However, in other embodiments of the invention the digital values may have an alternate form. For example, the digital values may be current values.

Each digital value represents the intensity of the down-converted radio signal 15 at a particular instance in time. In this particular example, the connection between the quantization circuitry 42 and the maintenance circuitry 44 is serial in nature, so one digital value is provided from the quantization circuitry 42 to the maintenance circuitry 44 at a time. However, those skilled in the art will realize that the connection may alternatively be parallel in nature, so that multiple digital values are provided from the quantization circuitry 42 to the maintenance circuitry 44 at a time.

At block 310 of FIG. 4, the maintenance circuitry 44 maintains a plurality of data groups. Each data group has a “data group number” and has a digital value range relating to a particular intensity range for the quantized signal. In this particular example, there are 400 data groups spanning a total digital value range of almost 400 mV.

The digital value range for each data group is chosen such that a value that is output by the quantization circuitry 42, below a certain threshold, falls into one of the data groups, more than one of the data groups, or all of the data groups.

In this example, the end point of the digital value range of each data group is 400 mV, because we are only considering signals below a threshold of 400 mV in this instance. The start point of the digital value range of each of the data group is, however, different.

The digital value range of data group number one spans the total digital value range of almost 400 mV. The digital value range of the first group is: 0 mV≦x<400 mV, where x is a digital value.

The digital value ranges for the other data groups are determined by successively incrementing the start point of the digital value range as the data group number is incremented. In this example, the increment value is 1 mV and there are 400 groups in total. For example, data group number two has a digital value range of 1 mV≦x<400 mV, data group number three has a digital value range of 2 mV≦x<400 mV and data group number 400 has a digital value range of 399 mV≦x<400 mV.

Each data group may comprise a cumulative parameter stored in the memory 50. In this example, when a digital value is produced by the quantization circuitry 42 and provided to the maintenance circuitry 44, the maintenance circuitry 44 allocates the produced digital value to one or more of the data groups. The maintenance circuitry 44 performs this task by determining which of the digital value ranges of the data groups a produced digital value falls within. Once appropriate digital value range(s) has/have been identified, the maintenance circuitry 44 allocates a digital value to the data group(s) defined by the identified digital value range(s) by updating the cumulative parameter for that/those data group(s). The maintenance circuitry 44 may, for example, allocate a produced digital value to a data group by incrementing the cumulative parameter of that data group by one.

For example, consider a situation in which the first digital value produced by the quantization circuitry 42 is 10 mV. The maintenance circuitry 44 determines that the produced digital value falls within the digital value ranges defining data groups numbers one to nine. The maintenance circuitry 44 therefore allocates the first digital value to each of data group numbers one to nine by incrementing the cumulative parameter of data group numbers one to nine, from zero to one. The cumulative parameters of data groups numbers ten to four-hundred are not updated in response to the production of the first digital value, and remain at zero.

The process of quantizing the down-converted radio frequency signal 15 and updating the cumulative parameters 54 of the data groups continues for a pre-determined amount of time. The predetermined amount of time may, for example, be one second. The cumulative parameters 54 are continually updated during the predetermined amount of time by writing the updated values to the memory 50.

The cumulative parameter of a data group indicates the number of times a digital value, falling within the digital value range for that data group, has been produced by the quantization circuitry 42 during the predetermined amount of time. As the digital value ranges of the data groups overlap one another and the earlier numbered data groups have larger digital ranges than the later numbered groups, the cumulative parameters 54 of the data groups form an inverse cumulative distribution. The inverse cumulative distribution provides an indication of how the digital values that have been produced by the quantization circuitry 42 have varied over time.

The form of the inverse cumulative distribution will depend upon how the intensity of the time-varying radio frequency signal 6 that is received by the antenna 10 varies over time.

In this example, the digital values produced from the quantization circuitry 42 are not themselves stored in the memory 50 by the maintenance circuitry 44. Once a digital value has been produced and the relevant cumulative parameter(s) has/have been updated, the digital value is discarded.

At block 320 of FIG. 4, the processing circuitry 46 processes at least some of the cumulative parameters of the data groups to determine whether the time-varying radio frequency signal 6 received at the antenna 10 originated from lightning.

There are a number of ways that the cumulative parameters may be processed in order to determine whether the received time-varying radio frequency signal 6 originated from lightning.

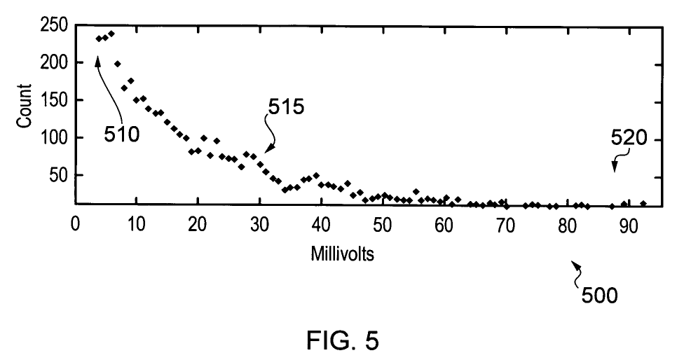

FIG. 5 illustrates an example of an inverse cumulative distribution formed from cumulative parameters. The distribution in FIG. 5 was formed from cumulative parameters derived from the radio signal illustrated in FIG. 3A, which was produced by lightning.

The y-axis of the graph 500 in FIG. 5 entitled “count” relates to the value of the cumulative parameters 54. The x-axis of the graph 500 entitled “millivolts” relates to the start point of the digital value ranges of the data groups. The data groups having the smallest data group numbers (and the largest digital value ranges) are therefore represented by the points on the left hand side 510 of the graph and the data groups having the largest data group numbers (and the smallest digital value ranges) are represented on the right hand side 520 of the graph.

The graph in FIG. 5 illustrates an exponentially decreasing curve. We would expect an inverse cumulative distribution formed from cumulative parameters that were derived from a radio signal produced by lightning to illustrate an exponentially decreasing curve, such as that illustrated in FIG. 5. This can be readily explained with reference to FIG. 3A, which is representative of a radio signal produced from lightning.

The graph 400 in FIG. 3A has an upper limit of 100 mV. However, assume that the illustrated signal always has a value that is less than 400 mV. Every digital value that is produced by the quantization circuitry 42 will therefore result in the maintenance circuitry 44 updating the cumulative parameter for the first data group (which has a digital value range of 0 mV≦x<400 mV).

The form of the lightning signal is such that as the start points of the digital value ranges of the data groups increase, it becomes increasingly unlikely that a produced digital value will fall within a digital value range. For example, the intensity of the signal in FIG. 3A is above 10 mV on many occasions, but it is only above 50 mV on fourteen occasions, and it is only above 100 mV on four occasions. The data groups with digital value ranges that have start points below 10 mV may therefore have cumulative parameters of a relatively high value in comparison with those with digital value range start points above 50 mV and 100 mV.

Thus, the inverse cumulative distribution for a lightning signal, formed from the cumulative parameters, is exponentially decreasing.

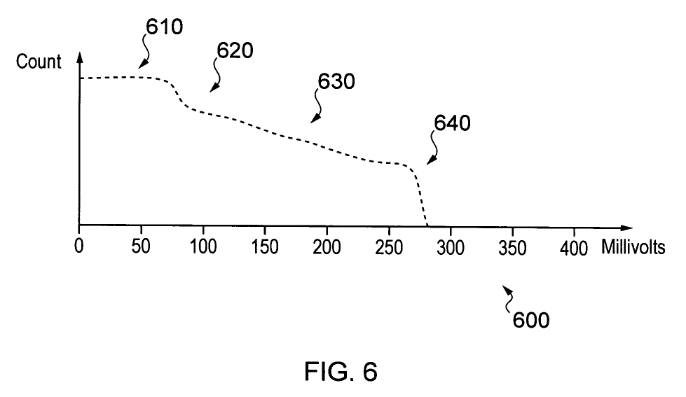

Turn now to FIG. 6, which also represents an inverse cumulative distribution formed from cumulative parameters 54. The distribution in FIG. 6 was formed from cumulative parameters 54 derived from the radio signal illustrated in FIG. 3B, which was produced by a man-made source.

The graph 600 illustrated in FIG. 6 was formed in a similar fashion to that on FIG. 5, in the sense that the y-axis of the graph 600 in FIG. 6 entitled “count” relates to the value of the cumulative parameters 54 and the x-axis of the graph 500 entitled “millivolts” relates to the start point of the digital value ranges of the data groups.

The intensity of the signal in FIG. 3B is consistently above a value of around 70 mV. The amplitude of the signal does not often have a value of around 70-90 mV. There are a number of peaks in the signal which have an amplitude of around 100 mV to 250 mV. The signal does not reach a value above 280 mV.

The first section 610 of the graph 600 in FIG. 6 represents the cumulative parameters of the data groups having digital value range start points of 0-70 mV. The first section 610 of the graph 600 is roughly constant, because all of the digital values produced from the signal in FIG. 3B fall within the data groups having a digital value range start point of 0-70 mV.

The second section 620 of the graph 600 in FIG. 6 illustrates a sharp drop in the graph relative to the first section 610 and the third section 630. The sharp drop in the second section 620 is a result of the signal in FIG. 3B not often having an intensity of around 70-90 mV.

The third section 630 of the graph 600 is a steady decline. The steady decline results because it becomes gradually less likely that a produced digital value will fall within a digital value range for a data group as the start point of the digital value range of the data groups increases from 90 mV to 270 mV.

The fourth section 640 of the graph is a very sharp drop towards zero counts at around 280 mV. This very sharp drop results because the amplitude of the signal in FIG. 3B does not rise above 280 mV.

It has been demonstrated that if cumulative parameters 54 are updated and stored in the manner explained above, an inverse cumulative distribution function formed from the cumulative parameters 54 that were derived from a radio signal originating from lightning should be a reasonably smooth, exponentially decreasing function.

On the contrary, an inverse cumulative distribution function formed from the cumulative parameters 54 that were derived from a radio signal originating from a man-made source will probably not be a reasonably smooth, exponentially decreasing function. Instead, the inverse cumulative distribution function is likely to include abrupt variations such as those in the second and fourth sections 620, 640 of the graph 600 illustrated in FIG. 6.

In order to determine whether a received radio signal 6 originated from lightning, the processing circuitry 46 processes at least some of the cumulative parameters 54 to determine whether they follow an exponentially decreasing trend. The processing circuitry 46 may, for example, process at least some of the cumulative parameters using a set of predefined rules.

There are a number of methods that may be used by the processing circuitry 46 to determine whether an inverse cumulative distribution function formed from stored cumulative parameters 54 is exponentially decreasing.

For example, the processing circuitry 46 may determine whether an inverse cumulative distribution function is exponentially decreasing by analyzing the derivative of the function. In order to do this, the processing circuitry 46 may subtract “adjacent” cumulative parameters from one another and determine whether the resulting value is an expected value. “Adjacent” cumulative parameters are considered to be cumulative parameters of adjacently-numbered data groups, such as the cumulative parameters from data groups one and two, for example.

If the resulting value is an expected value, the processing circuitry 46 may conclude that the received time-varying radio signal 6 originated from lightning. Otherwise, the processing circuitry 54 may conclude that the received time-varying radio signal 6 did not originate from lightning. The expected values may, for example be stored in trend data 56 stored in the memory 50.

For instance, consider a situation in which the processing circuitry 46 subtracts the cumulative parameter of data group number one from that of adjacent data group number two to obtain a first resulting value, and subtracts the cumulative parameter of data group number two from that of data group number three to obtain a second resulting value. The processing circuitry 46 may expect the second resulting value to be smaller than the first resulting value if the received time-varying radio frequency signal relates to lightning. Given that the inverse cumulative distribution function is expected to be exponential decreasing for a radio signal that originates from lightning, the processing circuitry 54 may expect increasingly smaller values to result as adjacent cumulative parameters of increasingly higher-numbered data groups are subtracted from one another.

If the processing circuitry 46 concludes that a radio signal originated from lightning, the apparatus 100 (or an electronic device of which the apparatus 100 forms a part) may provide a visual or aural warning to a user.

Consider now the graph 600 illustrated in FIG. 6. If adjacent cumulative parameters in the second section 620 or the fourth section 640 are subtracted from one another, a relatively large value is likely to result (due to the sharp variation in the graph 600 at these sections). That is, the resulting value may be (significantly) larger than values obtained from subtracting adjacent cumulative parameters of earlier-numbered adjacent data groups from one another.

Thus, in response to finding this relatively large value, the processing circuitry 54 may conclude that the inverse cumulative distribution does not follow an exponentially decreasing trend, which indicates that the received radio signal 6 originated from a man-made source.

A further way of processing the cumulative parameters (in addition or as an alternative to the above method) involves comparing selected cumulative parameters from non-adjacent data groups.

For example, the processing circuitry 46 may make a first comparison between a cumulative parameter of a data group having a digital value range start point of around 5 mV (indicated by the reference numeral 510 in FIG. 5) and a cumulative parameter of a data group having a digital value range start point of around 30 mV (indicated by the reference numeral 515 in FIG. 5). The processing circuitry 46 may, for example, make a second comparison between a cumulative parameter 54 of a data group having a digital value range start point of around 30 mV (indicated by the reference numeral 515 in FIG. 5) and a cumulative parameter of a data group having a digital value range start point of around 85 mV (indicated by the reference numeral 520 in FIG. 5).

The processing circuitry 12 may conclude that a received radio signal originated from lightning if: i) the first comparison indicates that the cumulative parameter of the data group having a digital value range start point of around 5 mV is very different from the cumulative parameter of the data group having a digital value range start point of around 30 mV, and/or if ii) the second comparison indicates that the cumulative parameter of the data group having a digital value range start point of around 30 mV is very different from the cumulative parameter of the data group having a digital value range start point of around 85 mV. It can be seen that this is the case for the relevant cumulative parameters illustrated in FIG. 5 (relating to a radio signal originating from lightning) but not for the cumulative parameters illustrated in FIG. 6 (relating to a radio signal originating from a man made source).

It will be apparent to those skilled in the art that when the processing circuitry 46 compares selected cumulative parameters from non-adjacent data groups, it is effectively determining whether a distribution, formed from the selected cumulative parameters, follows a particular trend. It will also be apparent to those skilled in the art that other types of comparisons could be made than those described above.

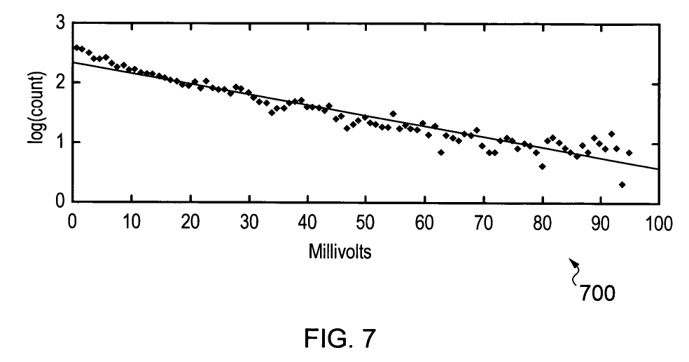

An alternative (or additional) way of processing the cumulative parameters 54 will now be explained with reference to the semi-log graph 700 illustrated in FIG. 7.

In order to produce the semi-log graph 700 illustrated in FIG. 7, cumulative parameters have been derived from the signal illustrated in FIG. 3A in the manner described above and then a logarithm has been taken of the cumulative parameters. The graph 700 in FIG. 7 is effectively the same as the graph 500 in FIG. 5, except the y-axis of the graph 700 represents a logarithm of the cumulative parameters.

As the inverse cumulative distribution function is expected to be an exponentially decreasing function for radio signals originated from lighting, the semi-log of the inverse cumulative distribution function, as illustrated in FIG. 7, is expected to be a straight line. It can be seen from FIG. 7 that the data points in the graph 700 approximate to a straight line.

Therefore, in order to determine whether a received radio signal 6 originated from lightning, the processing circuitry 46 may be configured to take the logarithm of the cumulative parameters and then to determine whether a distribution formed from the resulting values is in a straight line. The processing circuitry 54 may, for example, use a least-squares fit to determine whether a straight line is produced. A Chi-squared test could also be used.

If straight line is produced, the processing circuitry 46 concludes that the received radio signal 6 originated from lightning. If a straight line is not produced, the processing circuitry 46 concludes that the received radio signal 6 originated from a man-made source, and not lightning.

A method of determining whether a radio signal originates from lightning or a man-made source has been described above. In the described method, a cumulative parameter of a data group is updated when a digital value, falling within a digital value range, is produced by quantization circuitry 42.

The described method of updating and processing cumulative parameters 54 is advantageous because it means that it is not necessary to store the digital values produced by the quantization circuitry 42 in addition to the cumulative parameters in order to determine whether a radio signal originates from lightning. The number of cumulative parameters may be less than the number of digital values produced. Consequently, much less storage space may be required in the memory 50 than if the digital values were being stored in the memory 50 directly after quantization.

A “cumulative parameter” is considered to be “cumulative” in the sense that it is representative of the number of times produced digital values have fallen with a digital value range associated with that cumulative parameter.

It will be appreciated that reference to “cumulative” in the expression “cumulative parameter” does not necessarily mean that a set of cumulative parameters form a cumulative distribution (inverse or otherwise).

In the example described above, the cumulative parameters 54 form an inverse cumulative distribution due to the overlapping nature of the digital value ranges of each of the data groups. However, it is, for example, possible to configure the data groups such that the digital value ranges do not overlap. In such embodiments of the invention, each digital value produced by the quantization circuitry 42 would only fall within the digital value range of a single data group. A cumulative distribution (inverse or otherwise, such as those illustrated in FIGS. 5 and 6) could be formed by adding together appropriate cumulative parameters.

In these embodiments of the invention, relatively coarse quantization may, for example, be used such that it is not necessary for the maintenance circuitry 44 to allocate a produced digital value to a data group when updating a cumulative parameter.

In some embodiments of the invention, it is possible to process received radio signals to distinguish between different types of radio signals that originate from man-made sources.

For example, a user may generate a series of radio frequency pulses by sequentially switching the mains electricity supply of a building. The user may do this by, for instance, switching a light switch on and off. The sequential switching of the mains electricity supply causes radio frequency pulses to be emitted.

The radio frequency pulse sequence may, for example, be generated by switching the mains electricity supply in accordance with a particular rhythm (for example, by periodically switching a light switch on and off or switching a light switch in accordance with the rhythm of a particular song).

The generated radio frequency pulses are received at the antenna 10 of the apparatus 100 and passed to the analog processing part 20. The analog processing part 20 detects each radio frequency pulse as a “signal peak”. Each radio frequency pulse is passed to the down-converter 30 and is processed by the digital processing part 40 in the manner(s) described above.

The processing circuitry 46 of the digital processing part determines that the radio frequency pulses originate from a man-made source and not lightning. The processing circuitry 46 may then perform further processing techniques to determine one or more characteristics of the radio frequency pulses.

For example, the characteristics determined by the processing circuitry 46 may include: the duration of the radio frequency pulses, the time spacing between sequential radio frequency pulses, the number of radio frequency pulses received at the antenna 6 within a given time period, and/or the amplitude or intensity of the radio frequency pulses.

The processing circuitry 46 compares the one or more determined characteristics with one or more parameters stored in the memory 50. The parameters may, for example, be stored as part of the trend data 56. In the event that a determined characteristic corresponds with a stored parameter, the apparatus 100 may be configured to perform a function.

Consider a situation in which the apparatus 100 forms part of an electronic device such as a mobile radio telephone. In response to the processing circuitry 46 determining that a characteristic of received radio frequency pulses corresponds with a stored parameter, the processing circuitry 46 changes the mobile radio telephone from being in a first state to being in a second state.

When the mobile radio telephone is in the first state, it may be configured not to produce an audible alert in response to an incoming telephone call and/or an incoming text message. The first state may, for example, be a silent mode of the mobile radio telephone.

When the mobile radio telephone is in the second state, it may be configured to produce an audible alert. The mobile radio telephone may be configured to produce the audible alert in response to entering the second state. Alternatively or additionally, the mobile radio telephone may be configured to produce an audible alert, when in the second state, in response to an incoming telephone call and/or an incoming text message.

Thus, advantageously, embodiments of the invention may enable a user to find his mobile radio telephone if it is lost, by changing a state of the mobile radio telephone to enable it to be heard.

The blocks illustrated in the FIG. 4 may represent steps in a method and/or sections of code in the computer program. The illustration of a particular order to the blocks does not necessarily imply that there is a required or preferred order for the blocks and the order and arrangement of the block may be varied. Furthermore, it may be possible for some steps to be omitted.

Although embodiments of the present invention have been described in the preceding paragraphs with reference to various examples, it should be appreciated that modifications to the examples given can be made without departing from the scope of the invention as claimed. For example, while down-conversion of a received time-varying radio frequency signal is described above, it is not necessary to perform down-conversion.

In embodiments of the invention described above, the digital processing part 40 determines one or more characteristics of radio frequency pulses and compares it/them with one or more parameters. In alternative embodiments of the invention, this comparison may be made by the analog processing part 20.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. A method, comprising:
quantizing a received time-varying radio frequency signal to produce a series of digital values;
maintaining a plurality of data groups, each data group comprising a cumulative parameter and each data group being defined by a digital value range, wherein maintaining the plurality of data groups comprises updating a cumulative parameter of a data group, from the plurality of data groups, when a digital value, from the series of digital values, is within the digital value range for that data group; and
processing at least some of the cumulative parameters of the data groups to determine whether the received time-varying radio frequency signal originated from lightning.

2. A method as claimed in claim 1, wherein processing at least some of the cumulative parameters comprises determining whether a distribution, formed using at least some of the cumulative parameters, follows a trend.

3. A method as claimed in claim 1, wherein the number of digital values produced from quantizing the received time-varying radio frequency signal is greater than the number of maintained data groups.

4. A method as claimed in claim 1, further comprising storing, after updating cumulative parameters of the plurality of data groups, at least some of the updated cumulative parameters prior to processing, but not storing the produced series of digital values.

5. A method as claimed in claim 1, wherein maintaining the plurality of data groups comprises allocating a digital value, from the series of digital values, to a data group, from the plurality of data groups, prior to updating the cumulative parameter of that data group.

6. A method as claimed in claim 1, further comprising down-converting the time-varying radio frequency signal from a first frequency to a second, lower, frequency prior to quantizing the time-varying radio frequency signal.

7. A method as claimed in claim 6, wherein the second frequency is equivalent to an audio frequency and the time-varying radio frequency signal is quantized using audio processing circuitry.

8. An apparatus, comprising:
quantization circuitry configured to quantize a received time-varying radio frequency signal to produce a series of digital values;
maintenance circuitry configured to maintain a plurality of data groups, each data group comprising a cumulative parameter and each data group being defined by a digital value range, wherein maintaining the plurality of data groups comprises updating a cumulative parameter of a data group, from the plurality of data groups, when a digital value, from the series of digital values, is within the digital value range for that data group; and
processing circuitry configured to process at least some of the cumulative parameters of the data groups to determine whether the received time-varying radio frequency signal originated from lightning.

9. An apparatus as claimed in claim 8, wherein the processing circuitry is configured to process at least some of the cumulative parameters by determining whether a distribution, formed using at least some of cumulative parameters, follows a trend.

10. An apparatus as claimed in claim 8, wherein the number of digital values produced from quantizing the received time-varying radio frequency signal is greater than the number of maintained data groups.

11. An apparatus as claimed in claim 8, wherein the maintenance circuitry is configured to store, after updating cumulative parameters of the plurality of data groups, at least some of the updated cumulative parameters prior to processing, but not to store the produced series of digital values.

12. An apparatus as claimed in claim 8, wherein the maintenance circuitry is configured to allocate a digital value, from the series of digital values, to a data group, from the plurality of data groups, prior to updating the cumulative parameter of that data group.

13. An apparatus as claimed in claim 8, further comprising a down-converter configured to down-convert the time-varying radio frequency signal from a first frequency to a second, lower, frequency prior to quantizing the time-varying radio frequency signal.

14. An apparatus as claimed in claim 13, wherein the second frequency is equivalent to an audio frequency and the quantization circuitry is further configured to quantize received audio signals.

15. A tangible computer-readable storage medium storing a computer program comprising instructions which, when executed by a processor, enable:
maintaining a plurality of data groups, each data group comprising a cumulative parameter and each data group being defined by a digital value range, wherein maintaining the plurality of data groups comprises updating a cumulative parameter of a data group, from the plurality of data groups, when a digital value, produced from quantization of a received time-varying radio frequency signal, is within the digital value range for that data group; and
processing at least some of the cumulative parameters of the data groups to determine whether the received time-varying radio frequency signal originated from lightning.

16. A tangible computer-readable storage medium as claimed in claim 15, wherein processing at least some of the cumulative parameters comprises determining whether a distribution, formed using at least some of cumulative parameters, follows a trend.

17. A tangible computer-readable storage medium as claimed in claim 15, further comprising storing, after updating cumulative parameters of the plurality of data groups, at least some of the updated cumulative parameters prior to processing, but not storing the produced series of digital values.

18. A tangible computer-readable storage medium as claimed in claim 15, wherein maintaining the plurality of data groups comprises allocating a produced digital value to a data group, from the plurality of data groups, prior to updating the cumulative parameter of that data group.

19. An apparatus, comprising:
means for quantizing a received time-varying radio frequency signal to produce a series of digital values;
means for maintaining a plurality of data groups, each data group comprising a cumulative parameter and each data group being defined by a digital value range, wherein maintaining the plurality of data groups comprises updating a cumulative parameter of a data group, from the plurality of data groups, when a produced digital value, from the series of digital values, is within the digital value range for that data group; and
means for processing at least some of the cumulative parameters of the data groups to determine whether the received time-varying radio frequency signal originated from lightning.

20. An apparatus as claimed in claim 19, wherein the means for processing determines whether a distribution, formed using at least some of cumulative parameters, follows a trend.
